(19) United States
(12) Patent Application Publication
(10) Pub. No.: US 2024/0054460 A1
(43) Pub. Date: Feb. 15, 2024

(54) DEVICES, SYSTEMS, AND METHODS FOR PUBLIC/PRIVATE KEY AUTHENTICATION

(71) Applicant: Arculus Holdings, LLC, Somerset, NJ (US)

(72) Inventor: Adam Lowe, Somerset, NJ (US)

(73) Assignee: Arculus Holdings, LLC, Somerset, NJ (US)

(21) Appl. No.: 18/270,571

(22) PCT Filed: Jan. 7, 2022
(86) PCT No.: PCT/US2022/011660

§ 371 Date: Jun. 30, 2023

Related U.S. Application Data
(60) Provisional application No. 63/135,157, filed on Jan. 8, 2021.
(60) Provisional application No. 63/271,545, filed on Oct. 25, 2021.

(51) Int. Cl. G06Q 20/06; G06Q 20/32; G06Q 20/36

(52) U.S. Cl. CPC G06Q 20/065; G06Q 20/3278; G06Q 20/36

(57) ABSTRACT

A system for conducting authentication transactions, such as cryptocurrency transactions, includes a storage device with a secure element (SE) that digitally stores encrypted public and private keys, generates a public key using the private key, and performs sign and hash operations. A processing device (PD) is configured to establish a connection over NFC with the SE. The PD receives initiation of a transaction via a user interface, establishes an NFC link with the SE, and sends the SE information for processing via NFC. The secure element retrieves the private key, performs hash operations using the private key to generate a signature, confirms the signature conforms to a public key that could only have been generated using the private key, signs the transaction, and sends signed transaction information to the processing device. The processing device accesses a network and sends signed transaction information operative to complete the transaction.

### CROSS-REFERENCE TO RELATED APPLICATIONS

This Application is related to, and claims the benefits of priority of U.S. Provisional Application Nos. 63/135,157, filed 8 Jan. 2021, entitled CRYPTOCURRENCY DEVICES, SYSTEMS, AND METHODS and 63/271,545, filed 25 Oct. 2021, DEVICES, SYSTEMS, AND METHODS FOR PUBLIC/PRIVATE KEY AUTHENTICATION, the contents of which are incorporated herein by reference in their entirety for all purposes.

### BACKGROUND OF THE INVENTION

In the field of cryptocurrency (such as Bitcoin, etc.), a private key (the unique, typically alphanumeric, code that allows the currency to be spent) is required to access the cryptocurrency for spending purposes. A public key essentially identifies a destination for the currency. A transaction in cryptocurrency typically requires the sender and receiver to share their addresses that are the derivations of public keys with each other in order to complete the transaction, with the associate blockchain used to certify validity of the transaction and to confirm that the sender has the funds. For other types of authentication (e.g. FIDO or PGP), the sender and receive share their actual public keys. Once the payment has been delivered to the address, the receiver needs the private key to access the funds. Keeping the private key secure is therefore critical, because a user in possession of the private key may be able to access and convert the holder's cryptocurrency without authorization. An exemplary illustration of a derivation process from private key to public key to address can be found at https://iancoleman.io/bip39/, incorporated herein by reference.

A private key stored electronically in a digital wallet connected to the internet (i.e. a “hot wallet”) is vulnerable to hacking. When using a hot wallet, the method steps of conducting a transaction—generating and storing private keys, as well as digitally signing transactions using private keys—are typically performed by a single online device, which broadcasts the signed transaction over the network. A signed transaction broadcast over a network is vulnerable to attack.

“Cold storage” avoids the foregoing problems by signing the transaction using the private keys in an environment that not connected to the Internet. A transaction may be initiated online, but is then temporarily transferred to an offline wallet—such as electronic storage on a USB, CD, hard drive, or offline computer. The transaction is digitally signed offline before being transmitted to the online network. Because the private key is never present in an online location during the signing process, even if a hacker gains access the transaction details, the private key used to conduct the transaction is not discoverable.

While many systems and methods for accessing cold storage are known, they tend to be more burdensome than systems and methods for using a hot wallet, and therefore there remains a need in the art for cold storage device systems and methods of use that are more efficient.

### SUMMARY OF THE INVENTION

One aspect of the invention relates to a system for conducting cryptocurrency transactions. The system comprises a cryptocurrency cold storage device having an integrated circuit comprising a secure element. The term “secure element” as used herein refers not only to specifically designed microcontrollers referred to in the field or marketed specifically as secure elements (e.g. for use in credit cards and the like), but also to any microcontroller programmed with suitable security software for performing the functions of a secure element as known in the art. The secure element has a processor, a digital memory, and a first near field communications (NFC) interface. The secure element digital memory includes instructions readable by the secure element processor for causing the secure element to store a public key and a private key in encrypted states in the digital memory, generate a public key using the private key, and to perform sign and hash operations. In some embodiments, the public key may be shared from the secure element, for convenience. The system further includes a processing device, such as a mobile device, such as a smartphone, tablet, or laptop computer, having a user interface, a second NFC interface, and a communication interface configured for connection to a global communications network. The processing device has a digital memory and a processor, the digital memory programmed with instructions readable by the processor for causing the processing device to establish a secure connection over NFC with the secure element NFC interface, to send information to the secure element for processing by the secure element, and for establishing a cryptocurrency wallet operable for accessing a cryptocurrency network via the global communications network. The instructions readable by the cold storage device processor and the processing device processer, when read by the respective processors, are capable of causing the system to perform predetermined steps. The steps include the processing device receiving initiation of a transaction via the user interface, the transaction corresponding to a currency value or token. The processing device establishes a secure communications link with the secure element via NFC, and sends information to the secure element for processing via the NFC link. The secure element retrieves the private key, performs hash operations using the private key to generate a signature, decrypts the private key using the public key (i.e. checks a chain associated with public key to confirm that the signature conforms to the public key signature that could only have been generated using the specific private key), signs the transaction, and sends signed transaction information to the processing device. The processing device establishes a communication session over the global communications network with a cryptocurrency exchange server of the cryptocurrency network and sends the signed transaction information to the cryptocurrency exchange server (e.g. a node of the blockchain) to initiate a transaction operative to send the currency value or token to the exchange server. For example, once a block is signed and is ready to be added to the chain, the exchange server communicates with a node to push the transaction to the mempool (i.e. the waiting area for unconfirmed transactions).

The system may be configured to receive a cryptocurrency deposit, wherein the processing device is configured to display a cryptocurrency address associated with the cryptocurrency wallet in an encoded form for providing to a payor. The secure element may also comprise a payment module configured to exchange payment information with a card reader for conducting a purchase transaction. In a system with a single secure element, the single element may have a partition that separates the software for performing the cryptocurrency functions from the software for performing payment functions. Software may share information between applets, such a private keys or PINs. Each application is typically in its own “secure box”. Sharing between each secure box is possible, but may be relatively complicated. In other embodiments, a first secure element may be dedicated to performing cryptocurrency functions and a second secure element may be dedicated to performing payment functions.

In embodiments, the cold storage device comprises a card having standard dimensions of a transaction card in conformance with ISO/IEC 7810:2003 ID-1, such as a card comprising metal, ceramic, glass, or a combination thereof. In some embodiments, the card has no payment module and no magnetic stripe configured to interact with a card reader, whereas in other embodiments the card may further comprises at least one of a payment module and a magnetic stripe. In other embodiments, the cold storage device may be in the form of a key fob comprising metal, ceramic, glass, or a combination thereof.

The cold storage device and/or the processing device may further include a biometric reader module connected to the respective processor and configured to restrict activity of or access to the cold storage device based upon biometric information detected by the biometric reader.

Another aspect of the invention relates to a cryptocurrency cold storage device having an integrated circuit comprising a secure element. The secure element has a processor, a digital memory, and a near field communications (NFC) interface, such as but not limited to an interface configured for communication using the ISO 14443 standard. The secure element digital memory comprises programmed instructions readable by the secure element processor for causing the secure element to store a public key and a private key in encrypted states in the digital memory, generate a public key using the private key, and to perform sign and hash operations. The programmed instructions also cause the secure element to respond to receipt of high-level information from a mobile device linked via a secure communications link with the secure element via the NFC interface, the high-level information relating to a transaction corresponding to a currency value or token. The response includes retrieving the private key, performing hash operations using the private key to generate a signature, decrypting the private key using the public key (i.e. checking a chain associated with public key to confirm the signature conforms to a public key signature that could only have been generated using the specific private key), signing the transaction, and sending signed transaction information to the mobile device.

In some embodiments, the cold storage device comprises a card having standard dimensions of a transaction card in conformance with ISO/IEC 7810:2003 ID-1, such as a card comprising metal, ceramic, glass, or a combination thereof. The card may have no payment module and no magnetic stripe configured to interact with a card reader, or may have at least one of a payment module and a magnetic stripe. In other embodiments, the cold storage device comprises a key fob comprising metal, ceramic, glass, or a combination thereof. The cold storage device may include a biometric reader module connected to the processor and configured to restrict activity of the cold storage device based upon biometric information detected by the biometric reader.

Still other aspects of the invention relate to a processing device, such as a mobile device, such as a smart phone, having a user interface, a near field communications (NFC) interface, and a communications interface configured for connection to a global communications network. The processing device has a digital memory and a processor, the digital memory programmed with instructions readable by the processing device processor for causing the processing device to establish a secure connection over NFC with a secure element of a cryptocurrency cold storage device, to send information to the secure element for processing by the secure element, and for establishing a cryptocurrency wallet operable for accessing a cryptocurrency network via the global communications network. The instructions readable by the processing device processer are further configured to cause the processing device to perform the steps of (a) receiving initiation of a transaction via the user interface, the transaction corresponding to a currency value or token; establishing a secure communications link with the secure element via NFC; (c) sending high-level information to the secure element for processing via the NFC link; (d) receiving signed transaction information from the secure element; and (e) establishing a communication session over the global communications network with a cryptocurrency exchange server of the cryptocurrency network and sending the signed transaction information to the cryptocurrency exchange server to initiate a transaction operative to send the currency value or token to the exchange server.

### BRIEF DESCRIPTION OF THE DRAWINGS

FIG. 1 depicts an exemplary system for conducting a cryptocurrency transaction in accordance with aspects of the invention.

FIG. 2 is a flowchart depicting exemplary process steps in accordance with aspects of the invention.

### DETAILED DESCRIPTION OF THE INVENTION

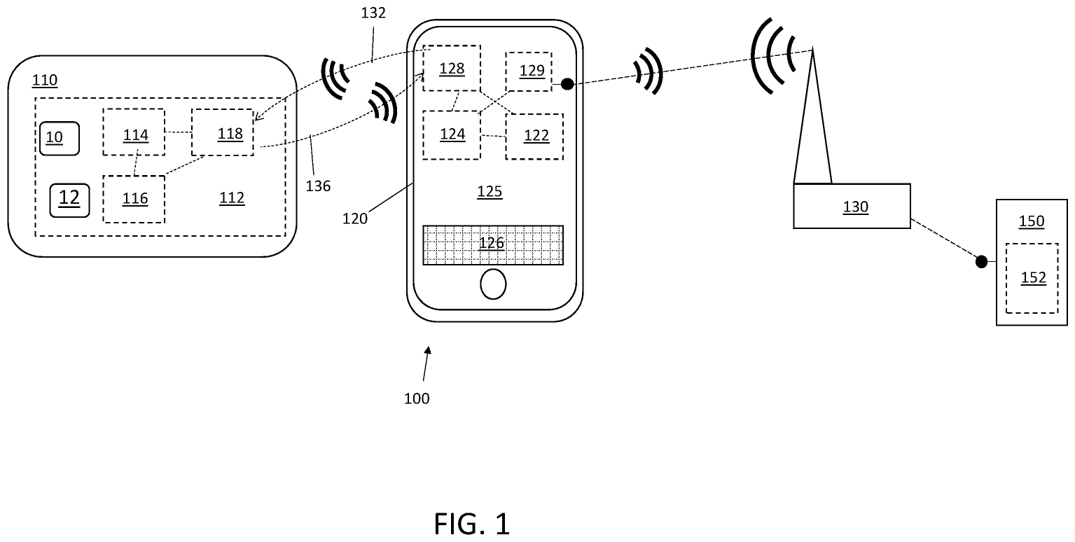

An exemplary system 100 for conducting cryptocurrency transactions in accordance with aspects of the invention is depicted in FIG. 1. Cryptocurrency cold storage device 110 is depicted in FIG. 1 in the form of a transaction card, such as a luxury card comprising metal, ceramic, glass, or a combination thereof, having standard dimensions of a transaction card in conformance with ISO/IEC 7810:2003 ID-1, namely a length and width of 85.6×53.98 mm (3.4×2.1 inches) and a thickness of 0.76 millimeters ( 1/32 in). Unlike a standard debit card or credit card, however, the card has no need for (and therefore lacks) a magnetic stripe and physical contacts associated with transaction cards configured for interacting with a card reader. Likewise, there is no need for a card number, a user name, or signature block on the card. In other embodiments, however, given the potential risks of loss and nature of the information stored on the cold storage device, embodiments with user-identifying information may have advantages. For example, features such as the user name (not shown but well understood in the art), user photo (not shown but well understood in the art), user signature block (not shown but well understood in the art), and a biometric reader 12 (e.g. comprising a fingerprint or thumbprint reader for controlling access to the cold storage device) may be included. In still other embodiments, cards may be configured to conduct routine credit card or debit card transactions, and may be thus configured with all of the typical trappings of a credit card, including a payment module 10, magnetic stripe (not shown but well understood in the art), and the like.

In some embodiments, there may be advantages to configuring the card or other form factor (fob, etc.) for payment plus authentication (e.g. using FIDO). It should be understood that in some embodiments, the card/other form factor may feature any combination of crypto, FIDO, access control/loyalty, and/or payment, depending on the combination of software.

Although depicted as a transaction card sized device, which offers the advantage of neatly fitting in a holder's physical wallet alongside standard transaction cards, the invention is not limited to any particular size or shape. Any form factor configured for NFC communications with a mobile device, as described herein, may be suitable. For example, the cold storage device may comprise a key fob, a coin, or any type of physical token. Although a construction of metal, ceramic, glass, or a combination thereof, is preferred for durability, the materials of construction are not limited.

Card 110 includes a secure element 112, which comprises an integrated circuit having a processor 114, a digital memory 116, and a near field communications (NFC) interface 118. The secure element 112 digital memory 116 includes a cryptographic module embodying instructions readable by the secure element processor 114 for causing the secure element to store a public key and a private key in encrypted states in the digital memory, generate a public key using the private key, and to perform sign and hash operations.

The NFC interface may include one or more antennas, including in some embodiments, particularly embodiments in which the card comprises metal, a first antenna integrated within an integrated circuit (IC) chip that contains the secure element, and a second (booster) antenna comprising a layer of the card. In some embodiments, a metal layer of the card itself may be configured as the antenna. Configurations of metal cards with operable NFC interfaces are described, for example but not limited thereto, in U.S. Pat. No. 10,318,859, titled DUAL INTERFACE METAL SMART CARD WITH BOOSTER ANTENNA, and U.S. Pat. No. 10,762,412, titled DI CAPACITIVE EMBEDDED METAL CARD, both of which are incorporated herein by reference. Although described in the foregoing in the context of payment modules comprising secure elements for communicating with card readers, the NFC interfaces as described therein are comparable to those used between the cards and processing devices discussed herein.

Mobile device 120, such as a smart phone, tablet, or other type of computer, also referred to herein as a processing device (PD), includes a user interface 126, and is configured for connection to a global communications network 130. The mobile device has a digital memory 122, a processor 124, and a mobile device NFC communication interface 128. The mobile device digital memory 122 is programmed with instructions readable by the mobile device processor 124 for causing the mobile device to establish a secure connection with the secure element NFC interface 118 using the NFC communication interface 128 on the mobile device, and to send information to the secure element 112 for processing by the secure element. Mobile device 120 is also configured for establishing a cryptocurrency wallet 129 operable for accessing a cryptocurrency network 150 via the global communications network 130. Access to the cryptocurrency network may be direct or indirect (i.e. the wallet may directly interact with a second layer cryptocurrency network, such via the Lightning Network or via Decentralized Finance (DeFi) protocols (e.g. Compound or Uniswap) over their respective chains, as non-limiting examples.

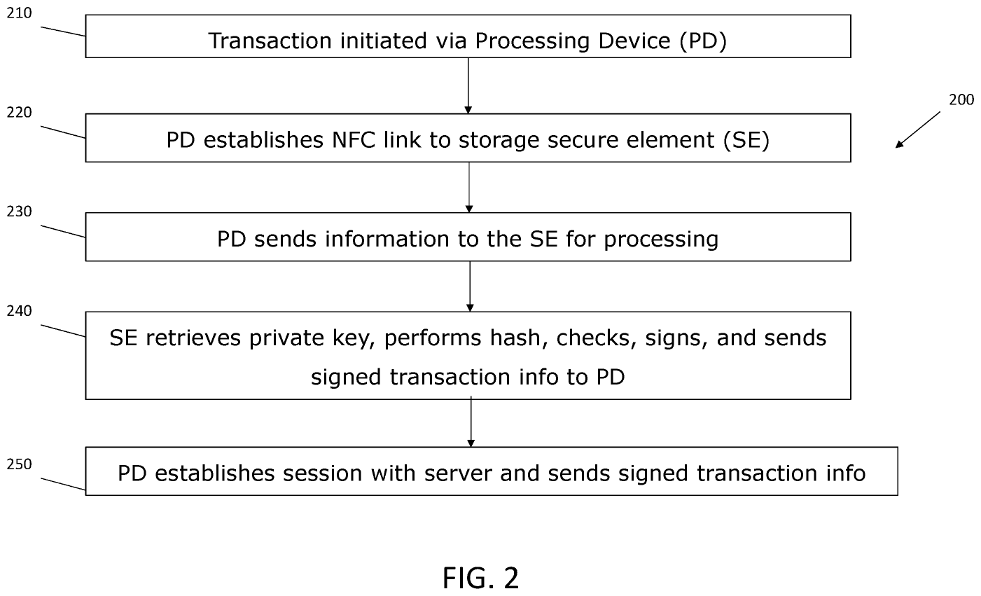

The instructions readable by the cold storage device processor 114 and the mobile device processer 124, when read by the respective processors from the memory connected thereto, are capable of causing the system to perform the steps needed to process a cryptocurrency transaction. In a typical process 200, summarized in the flowchart depicted in FIG. 2, a transaction, corresponding to a transfer of currency having a value, is initiated by a user via the user interface 126 of the processing device (PD) (e.g. mobile device 120), in step 210. The mobile device 120 establishes a communications link, such as a secure communications link (e.g. encrypted), with the secure element (SE) via NFC between the respective NFC interfaces 118, 128 in step 220, over which the mobile device in step 230 sends high-level information to the secure element for processing in communication 132. The secure element processor 114, in step 240, retrieves the private key from memory 116, performs hash operations using the private key to generate a signature, decrypts the private key using the public key stored in memory 116 (i.e. checks the chain associated with public key to confirm that the signature conforms to the public key signature that could only have been generated using the specific private key), signs the transaction, and sends signed transaction information back to the mobile device, such as via an NFC communication 136. This communication may or may not be encrypted.

In step 250, mobile device 120 then establishes a communication session over the global communications network 130 with a cryptocurrency exchange server 152 of the cryptocurrency network 150 and sends the signed transaction information to the cryptocurrency exchange, which initiates a transaction operative to send the currency value or token to the exchange server.

System 100 may be further configured to receive a cryptocurrency deposit. A method for facilitating such a deposit may include the mobile device displaying on display 125 a cryptocurrency address associated with the cryptocurrency wallet in an encoded form for providing to a payor. For example, the address may be in the form of a bar code or QR code that the payor can capture with the payor's mobile device. The system may also read an address from a NFC or other wireless signal. The system may further be configured to conduct any type of cryptocurrency transaction, such as purchasing cryptocurrency (i.e. using fiat currency) or swapping cryptocurrencies (i.e. trading an amount of one cryptocurrency for an equivalent amount of another cryptocurrency).

In some embodiments, secure element 112 may also comprise a payment module 10 configured to exchange payment information with a card reader for conducting a purchase transaction. Such a payment module 10 may be unconnected to portions of the secure element for processing cryptocurrency transactions, or may be connected and usable for initiating a payment transaction using the secure element. In embodiments in which the payment module is connected to the portion of the secure element configured for processing cryptocurrency transactions, rather than the transaction being initiated by the mobile device, the cold storage device may establish the connection with the mobile device. This connection may prompt the initiation of the transaction, and the remaining portions of the transaction may occur as described above. In an embodiment in which the payment module is not connected to the cryptocurrency processing portion of the secure element, the processing of a payment using the payment module may be a standard credit card or debit card transaction, with the payment module co-located on the cold storage device solely for convenience. In other embodiments, the payment transaction may prompt a standard credit or debit card transaction that is communicated to the mobile device for authorization and satisfaction of the transaction, in which case the mobile device may then initiate the cryptocurrency transaction as described above to satisfy the payment. Systems configured to conduct both the cryptocurrency functions as described herein and payment transactions may feature a single secure element (SE) or dual SEs (e.g. one in the payment module, such as in a dual interface (DI) chip, and the other embedded elsewhere in the card). Single SE may have secure “boxes” (i.e. hardware or software partitions within the chip that isolate the payment from the crypto portions of the SE so that a hack into the payment software of the SE would not provide a pathway to the crypto software, and vice-versa).

In embodiments with a biometric reader 10, the biometric reader 10 may be connected to the processor 114 and memory 116, with the processor configured to receive biometric data detected by the reader, compare it to stored biometric data, and allowing further processing only when the comparison reveals a match between the read and stored data to a predetermined degree of similarity. In other embodiments, a biometric checkpoint may be implemented on the mobile device instead of (or in addition to) the biometric securing provided on the card.

In exemplary embodiments, the storage and functions relating to the public and private keys may comprise a first applet, and one or more second, standard payment applets may also sit on the secure element without any interaction between the respective applets.

Most of the sequence relating to the cryptocurrency transactions is well known, such as defined by the Bitcoin protocol or BIP32/39, “Bitcoin Improvement Protocol” updates. In one embodiment, the steps are implemented inside a Java applet running on the secure element. Keys are generated inside the secure element, which may be, for example, an SLC37 security microcontroller from Infineon Technologies, and are stored in encrypted form in a secure keystone. The keys do not leave the card and are known outside by their logical indexes, but not real values. All sign and hash operations are done using the secure element. In essence, the software embedded in the card manages all cryptocurrency cryptographic primitives. A mobile applet on the mobile device (e.g. running on an Android/iOS operating system) sends the relevant, high-level information to the card for processing. Then, once the mobile applet receives the signed transaction from the card, it establishes communication session with a crypto exchange and sends this data to initiate a transaction.

Although the invention is illustrated and described herein with reference to specific embodiments, the invention is not intended to be limited to the details shown. Rather, various modifications may be made in the details within the scope and range of equivalents of the claims and without departing from the invention.

In particular, although illustrated with respect to cryptocurrency transactions, the methods, systems, storage device, and processing devices as discussed herein may be used in connection with conducting any type of transaction (not limited to financial transactions), and may include any type of public key/private key authentication known in the art. For example, the storage device as described herein may be paired with a transaction application on a mobile device to conduct any type of transaction, including authentications using the FIDO® standard. The initiation of the transaction may take any form, such as a push from a first device connected to a network that prompts a second device connected to the network, provision of a code (e.g. a QR code) displayed by a first device (or embodied in a physical manifestation such as a printed document) read by a second device, or may be initiated by the user using the transaction application user interface on the device, or by the user using the storage device placed in an activation proximity to the mobile device capable of exchanging information with the storage device. The initiated is not limited to any particular method. In some embodiments, the card may also or instead be used as an authentication token for hot wallets or other online accounts using the same or similar cryptographic primitives as described above. In such embodiments, the secure element in the card may exchange encryption credentials through the mobile device hosting the online account. This exchange may occur during initial setup. For example, a PGP key exchange between the two devices may be performed via an applet. A simple recognition token may then be verified via an encrypted channel during subsequent transactions that matches the token during initial registration. A card so configured may function as an independent factor of authentication, but does not sign any cryptocurrency transaction as it does not maintain the keys. Keys may be federated across multiple platforms with further software interactions.

What is claimed:

1. A system for conducting a transaction, comprising:
a storage device, the storage device having an integrated circuit comprising at least a first secure element, the first secure element having a processor, a digital memory, and a first near field communications (NFC) interface, the first secure element digital memory module embodying instructions readable by the first secure element processor for causing the first secure element to store a public key and a private key in encrypted states in the digital memory, generate a public key using the private key, and to perform sign and hash operations;
a processing device having a user interface, a second NFC interface, and a communication interface configured for connection to a global communications network, the processing device having a digital memory and a processor, the processing device digital memory programmed with instructions readable by the processing device processor for causing the processing device to establish a connection over NFC with the first secure element NFC interface, to send information to the first secure element for processing by the first secure element, and for establishing a user interface operable for accessing a transaction network via the global communications network;
wherein instructions readable by the storage device processor and the processing device processer, when read by the respective processors, are capable of causing the system to perform the steps of:
(a) the processing device receiving initiation of a transaction via the user interface;
(b) the processing device establishing the connection with the first secure element via NFC;
(c) the processing device sending information to the first secure element for processing via the NFC link;
(d) the first secure element retrieving the private key, performing hash operations using the private key to define a signature, checking a chain associated with the public key to confirm that the signature conforms to a public key signature that could only have been generated using the specific private key, signing the transaction, and sending signed transaction information to the processing device;
(e) the processing device establishing a communication session over the global communications network with an exchange server of the transaction network and sending the signed transaction information to the exchange server to initiate the transaction.

2. The system of claim 1, wherein the transaction comprises a cryptocurrency transaction corresponding to a currency value or token, the storage device comprises a cryptocurrency cold storage device, the first secure element digital memory module comprises a cryptographic module, and the user interface comprises a cryptocurrency virtual wallet.

3. The system of claim 2, wherein cryptocurrency virtual wallet is configured to access the transaction network indirectly through direct access to a second layer cryptocurrency network.

4. The system of claim 2, wherein the system is further configured to receive a cryptocurrency deposit, wherein the processing device is configured to display a cryptocurrency address associated with the cryptocurrency wallet in an encoded form for providing to a payor.

5. The system of claim 2, wherein the system is further configured to buy or swap cryptocurrency.

6. The system of claim 2, wherein the first secure element also comprises a payment module configured to exchange payment information with a card reader for conducting a purchase transaction.

7. The system of claim 6, wherein the payment module is isolated from the cryptocurrency module in the cold storage device first secure element, which comprises an only secure element in the cold storage device.

8. The system of claim 2, wherein the cold storage device includes a second secure element comprising a payment module configured to exchange payment information with a card reader for conducting a purchase transaction.

9. The system of claim 1, wherein the processing device comprises a mobile device.

10. The system of claim 9, wherein the mobile device comprises one of a smartphone, a tablet, or a laptop computer.

11. The system of claim 1, wherein the storage device comprises a card having standard dimensions of a transaction card in conformance with ISO/IEC 7810:2003 ID-1.

12. The system of claim 11, wherein the card comprises metal, ceramic, glass, or a combination thereof.

13. The system of claim 2, wherein the storage device comprises a card having standard dimensions of a transaction card in conformance with ISO/IEC 7810:2003 ID-1, and the card has no payment module and no magnetic stripe configured to interact with a card reader.

14. The system of claim 13, wherein the card further comprises at least one of a payment module and a magnetic stripe configured to interact with a card reader.

15. The system of claim 1, wherein the storage device comprises a key fob comprising metal, ceramic, glass, or a combination thereof.

16. The system of claim 1, wherein the storage device further comprises a biometric reader module connected to the processor and configured to restrict activity of the storage device based upon biometric information detected by the biometric reader.

17. The system of claim 1, wherein the processing device further comprises a biometric reader module connected to the processing device processor and configured to restrict access to the storage device from the processing device based upon biometric information detected by the biometric reader.

18. The system of claim 1, wherein the connection between the processing device and the first secure element is a secure NFC communication link.

19. A storage device, the device having an integrated circuit comprising at least a first secure element, the first secure element having a processor, a digital memory, and a near field communications (NFC) interface, the first secure element digital memory comprising a module embodying instructions readable by the first secure element processor for causing the first secure element to store a public key and a private key in encrypted states in the digital memory, generate a public key using the private key, and to perform sign and hash operations, and for causing the first secure element to, in response to receipt of high-level information from a mobile device linked via a communications link with the first secure element via the NFC interface, the high-level information relating to a transaction, perform the steps of:
retrieving the private key, performing hash operations using the private key to define a signature, checking a chain associated with the public key to confirm that the signature conforms to a public key signature that could only have been generated using the specific private key signing the transaction, and sending signed transaction information to the mobile device.

20. The storage device of claim 19, wherein the storage device comprises a card having standard dimensions of a transaction card in conformance with ISO/IEC 7810:2003 ID-1.

21. The storage device of claim 20, wherein the card comprises metal, ceramic, glass, or a combination thereof.

22. The storage device of claim 17, wherein the storage device comprises cryptocurrency cold storage device, the transaction corresponds to a currency value or token, and the module comprises a cryptographic module.

23. The storage device of claim 22, wherein the card has no payment module and no magnetic stripe configured to interact with a card reader.

24. The storage device of claim 20, wherein the card further comprises a magnetic stripe configured to interact with a card reader.

25. The storage device of claim 19, wherein the card further comprises a payment module.

26. The storage device of claim 25, wherein the payment module is isolated from the module in the storage device first secure element, which comprises an only secure element in the cold storage device.

27. The storage device of claim 25, wherein the storage device includes a second secure element comprising the payment module configured to exchange payment information with a card reader for conducting a purchase transaction.

28. The storage device of claim 19, wherein the cold storage device comprises a key fob comprising metal, ceramic, glass, or a combination thereof.

29. The storage device of claim 19, wherein the storage device further comprises a biometric reader module connected to the processor and configured to restrict activity of the storage device based upon biometric information detected by the biometric reader.

30. The storage device of claim 19, wherein the communications link is a secure communications link.

31. A processing device having a device user interface, a near field communications (NFC) interface, and a communications interface configured for connection to a global communications network, the processing device having a digital memory and a processor, the processing device digital memory programmed with instructions readable by the processing device processor for causing the processing device to establish a connection over NFC with a secure element of a storage device, to send information to the secure element for processing by the secure element, and for establishing a transaction application user interface operable for accessing a transaction network via the global communications network, the instructions readable by processing device processer further configured to cause the processing device to perform the steps of:
(a) receiving initiation of a transaction via the device user interface;
(b) establishing a communications link with the secure element via NFC;
(c) sending high-level information to the secure element for processing via the NFC link;
(d) receiving signed transaction information from the secure element;
(e) establishing a communication session over the global communications network with an exchange server of the transaction network and sending the signed transaction information to the exchange server to initiate a transaction.

32. The processing device of claim 31, wherein the storage device is a cryptocurrency cold storage device, the transaction application user interface comprises a cryptocurrency wallet, the transaction network is a cryptocurrency network, and the transaction corresponds to a currency value or token.

33. The processing device of claim 31, wherein the processing device comprises a mobile device.

34. The processing device of claim 33, wherein the mobile device comprises a smart phone.

35. The processing device of claim 19, further comprising a biometric reader module connected to the processor and configured to restrict access to the storage device from the processing device based upon biometric information detected by the biometric reader.

36. The processing device of claim 19, wherein the connection over NFC with the secure element is a secure communication.

37. An authentication device, the device having an integrated circuit comprising at least a first secure element, the first secure element having a processor, a digital memory, and a near field communications (NFC) interface, the first secure element digital memory comprising a module embodying instructions readable by the first secure element processor for causing the first secure element to store an authentication code in the digital memory, and to transmit the authentication information to a mobile device in response to receipt of a communication from the mobile device linked via a communications link with the first secure element via the NFC interface, the information relating to a transaction.

38. The authentication device of claim 37, wherein the authentication device is a cryptocurrency authentication device, the module comprises a cryptographic module, and the transaction corresponds to a currency value or token.

39. A system for conducting transactions, comprising:
an authentication device, the authentication device having an integrated circuit comprising at least a first secure element, the first secure element having a processor, a digital memory, and a first near field communications (NFC) interface, the first secure element digital memory comprising a transaction module embodying instructions readable by the first secure element processor for causing the first secure element to store an authentication code in the digital memory;
a processing device having a user interface, a second NFC interface, and a communication interface configured for connection to a global communications network, the processing device having a digital memory and a processor, the processing device digital memory programmed with instructions readable by the processing device processor for causing the processing device to establish a connection over NFC with the first secure element NFC interface, to send a communication to the first secure element, for establishing a transaction application user interface operable for accessing an online a transaction account via the global communications network;
the online transaction account comprising a public key and a private key in encrypted states stored in the transaction account digital memory and instructions readable by a transaction account processor for storing and generate a public key using the private key, to perform sign and hash operations, and to transmit signed transaction information to a transaction exchange server of a transaction network;
wherein instructions readable by the authentication device processor and the processing device processer, when read by the respective processors, are capable of causing the system to perform the steps of:
(a) the processing device receiving initiation of a transaction via the user interface;
(b) the processing device establishing the connection with the first secure element via NFC;
(c) the processing device sending a communication to the first secure element via the NFC link;
(d) the first secure element sending the authentication code to the processing device;
(e) the processing device establishing a communication session over the global communications network with the online transaction account and sending the authentication code to the online transaction account; and
(f) the online transaction account retrieving the private key, performing hash operations with the private key to generate a signature, checking a chain associated with the public key to confirm that signature conforms to a public key signature that could only have been generated using the private key, signing the transaction, and sending signed transaction information to the transaction exchange server to initiate a transaction.

40. The system of claim 39, wherein the system comprises a cryptocurrency transaction system, the authentication device comprises a cryptocurrency authentication device, the module comprises a cryptocurrency module, the transaction application user interface comprises a cryptocurrency wallet, the online transaction account comprises a cryptocurrency account, the transaction network is a cryptocurrency network, the exchange server is a cryptocurrency exchange server, and the transaction comprises a cryptocurrency transaction operative to send a currency value or token to the exchange server.
